(19) United States
(12) Patent Application Publication
(10) Pub. No.: US 2017/0306848 A1
(43) Pub. Date: Oct. 26, 2017

(54) METHOD FOR IMPROVING THE PERFORMANCE AND EFFICIENCY OF DIESEL, GAS-TURBINE, TURBO-JET COMBUSTION ENGINE

(71) Applicant: ASTROTANE, LLC, Attleboro, MA (US)

(72) Inventor: Alexander Vasilievich Shatalov, Shchyolkovo City (RU)

(21) Appl. No.: 15/373,089

(22) Filed: Dec. 8, 2016

(30) Foreign Application Priority Data
Apr. 25, 2016 (RU) 2016115945

(51) Int. Cl. F02C 7/224; F02C 3/30; F02K 3/08

(52) U.S. Cl. CPC F02C 7/224; F02K 3/08; F02C 3/30; F05D 2260/99; F05D 2240/36

(57) ABSTRACT

The invention relates to a method for improving the performance and efficiency of diesel, gas-turbine, and turbojet combustion engines. The technical result is the creation of conditions for the formation of the open flame formed by burning (oxidation) of hydcerocarbon gases released directly at the moment the fuel is fed into combustion chamber. Consequently, it increases the efficiency and performance of the internal combustion engine. The claimed result is achieved by method of increasing the efficiency and performance of diesel, gas-turbine, turbojet internal combustion engines, which includes the following steps: obtaining hydrogen containing gas from a portion of fuel, previously split by way of overheating; injection into the combustion chamber previously split fuel; obtaining the flame of hydrogen-containing gases at the moment of injection; obtaining the effect of flaring combustion of the major portion of the injected fuel.

### CROSS-REFERENCE TO RELATED APPLICATION

This patent documents claims priority to earlier filed Russian Patent Application No. 2016115945, filed on Apr. 25, 2016, the entire contents of which are incorporated herein by reference.

### BACKGROUND OF THE INVENTION

### 1. Field of the Invention

The invention relates to combustion engines and more specifically a method for improving the performance and efficiency of diesel, gas-turbine, and turbo-jet combustion engines.

### 2. Background of the Related Art

There are ways to improve the performance and efficiency of internal combustion engines (http://www.common-rail.ru/tech/tech_05.php, was discovered 26 Mar. 2016) due to mechanical devices, such as: turbo supercharge, compound for diesels; multi-contour, segmented division of the combustion chambers for turbojet engines; turbo supercharge (boost), the compound, and direct electronic injection for gasoline engines.

Recent advances in diesel building became fuel electronic system “Common Rail”—through joint development of “Bosch” and “Siemens”, in which the following is used: pressure accumulator, multiphase injection and extremely high values of pressure, as compared to previous fuel systems.

The use of the pressure accumulator has led to more uniform distribution of fuel to the engine cylinders.

The high pressure allows for the use of a multi-phase injection, in which, during the time allotted for the injection of fuel, there are several short injections. Wherein the magnitude of the harmful effects of the detonation engine has decreased, thus increasing the compression ratio. A better way of distribution and mixing fuel with air is within the cylinder,

The high pressure allows for the achievement of a smaller drop of fuel during injection, thereby increasing the total sum of the area of the fuel film, simultaneously, comes into contact with a superhot air within the cylinder, resulting in improved fuel combustion. Ultimately it comes close to the effects of homogeneous combustion. For stability, the electronic control system monitors all processes.

However, the small drop will evaporate, decompose, and only then, will oxidize—to combust. In addition, the formation of peroxide groups, which causes detonation in the fuel oxidation reaction—combustion, manifests itself differently for different load conditions. Also different levels of detonation occur during the power stroke, depending on the piston position relative to the TP—terminal point, that is not considered by the authors in “Common Rail”.

### SUMMARY OF THE INVENTION

The technical result is the creation of conditions for the formation of the open flame formed by burning (oxidation) of hydrocarbon gases released directly at the moment the fuel is fed into combustion chamber. Consequently, it increases the efficiency and performance of the internal combustion engine.

The claimed result is achieved by method of increasing the efficiency and performance of diesel, gas-turbine, turbojet internal combustion engines, which includes the following steps: obtaining hydrogen containing gas from a portion of fuel, previously split by way of overheating; injection into the combustion chamber previously split fuel; obtaining the flame of hydrogen-containing gases at the moment of injection; obtaining the effect of flaring combustion of the major portion of the injected fuel.

According to the invention, at the time of the injection of previously overheated liquid-fuel, water is supplied in parallel.

According to the invention, previously overheated liquid fuel, with water dissolved in it, is supplied to the fuel combustion chamber. The water, in this case, is under the impact of extreme temperatures Tₑₓₜᵣ≧374° C. at a pressure P≧218 atm.

### DETAILED DESCRIPTION OF THE PREFERRED EMBODIMENTS

In the proposed method, the fuel that enters the combustion chamber: either the whole volume can undergo splitting by a preliminary overheating above the self-ignition temperature, in a special chamber and stay there in the converted—modified state, or can be divided into parts, one or more of which is subject to overheating above the self-ignition temperature in a special chamber and present there in the converted—modified state.

Converted (transformed, modified) condition of the fuel characterized by the ability and willingness to split (decompose) in less time, with the formation of hydrogenous gases CH₄, C₂H₆, C₃H₃, C₄H₁₀ and their derivatives at a pressure drop—at a transition from the fuel system into combustion chamber, and as a result, an increased activity of the oxidation (combustion). According to this, splitting of the fuel, while obtaining hydrogen-containing gases, can be done directly in the injection device, or obtaining the hydrogen-containing gas from the portion of the split, can be done before its injection, for example, in the additional heating chamber of the liquid fuel.

The activity of oxidation will increase so much that, at the moment of injection, a jet flame is formed, but still not an explosion—a torch, combustion rate of which significantly exceeds the rate of injection and combustion of the main charge.

The thermal and radiant energy released by the torch, will be involved faster in the combustion process of the main charge of fuel and mainly “slow-burning” hydrocarbons, thus ensuring faster (from 2 to 10 times, depending on the amount of the resulting hydrogen-containing gas and loading engine conditions), and more complete combustion.

The increasing combustion rates will lead to an increase in capacity, will reduce the lead angle of injection for those same diesel engines, thereby “softening” the work done by the engine, and will allow the increase of the compression ratio and the supercharged air pressure.

In the case of combining the proposed method with the fuel system of Common Rail or using multiphase fuel injection separately, it is proposed to apply different durations of injection phase, with respect to each other, which will additionally reduce the rate of detonation, and therefore, will further increase the compression ratio and the supercharge air pressure.

A velocity increase in the fuel combustion for the turbojet engines is a direct increase in power, which will lead to an increase in fuel economy as well.

In this specific case, the claimed process provides for the use of water as an additional source of working agent, able to perform work. This case is fundamentally different from the aforementioned and other existing ways to improve effectiveness and fuel economy of engines, including those equipped with fuel systems of the Common Rail.

Water is known to be used in diesel engines: in the form of steam to liquefy the diesel fuel; in the form of water, injected into the intake manifold—however, with this use of water we can only talk about the humidification of the intake air.

Using water in water-fuel emulsions, which is becoming more common, where fuel accounts for 79%, water 18-20% and 1-3% emulsifier. However, the use of such an emulsion is difficult in cold climates. The emulsion must be prepared in advance, the emulsion storage is limited in time, and in some cases, emulsions segregate and need to be re-emulsified. There are other disadvantages to the use of water-fuel emulsions, but the achieved effect is ≈20% fuel economy, which is so high, that the deficiencies can be neglected.

In the proposed method, water is supplied in parallel with the fuel in liquid form, by the jet or spray, directly into the combustion chamber. The increased activity of the fuel to oxidation, in the proposed method, allows for the full flow of combustion processes. In this case, the water supply, and its content are more than 20 percent relative to the fuel quantity. Introduced into the combustion zone, water will heat up, evaporate and expand, filling the total working volume of working agent (working fluid), obtained by chemical reaction of oxidation of fuel and air directly in the combustion chamber.

As known, the water has a very high coefficient of volume expansion during evaporation and further expansion (Kw·exp=1750). It is this property of water that will be used in the proposed method as the primary. Expansion of the water will be much slower than the combustion process, as a result, pressure will continue to grow for some time after the end of the working process of the formation of the main agent, obtained by chemical reaction of fuel and air. Additional work will be done.

When using the water supplied to the cylinders by jet or spray, the proposed method suggests to have two modes of operation, “summer” and “winter”. This is a simpler transition from mode to mode than to a prepare water-fuel emulsions. This method also has the ability to easily release the system from water in conditions of low temperatures.

Increasing the amount of working agent in turbojet engines, operating on land and water: (turbo CHP, turbo-vessels, turbo-locomotives) will allow the increase of the total area of working surfaces of the blade part of the turbines, will reconfigure the blades to select more power and move the concept of power in the direction of increasing torque. The flow velocity thus drops as a consequence of the increase in combustion rate of fuel, despite the fact that the expansion of the water takes place with heat absorption.

The absorption of heat by expandable water in diesel engines will entail a reduction in the overall temperature of the engine mode, which allows further increase of the compression ratio or increase of the pressure of the supercharged air.

This method allows the use of no less than 20% water for diesel engines and 30% for turbine engines, and achieves increased fuel economy only through the use of more than 20% water and 10% fuel conversion to form a torch of hydrogen-containing gases, all of which add up to >30% economy for diesel engines without increasing the compression ratio. That is approximately equal to 8-10% efficiency or a flow of 140 g/kW for turbo supercharged diesel engines and 130 g/kW for diesel engines with turbo supercharge and compound.

For turbojet engines, operating on land and water, where it is possible to use the entire spectrum of actions to improve work efficiency and increase savings of the engines—the actions include: the use of water, fuel conversion and a change in the parameters of working part of the turbine. The result is a 40% increase in fuel economy, or approximately 12-15% efficiency. These results were confirmed in practice.

Water use will eliminate phenomena such as bedding rings or coking of the combustion chamber.

Application of this method will improve the environmental performance of the engines through two paths: 1) by improving the combustion efficiency, due to formation of the torch from hydrogen-containing gases, which are more effective for oxidation; 2) by achieving significant fuel economy, which is characterized by a decrease in the total amount of fuel burnt per unit of time, and consequently decreasing the amount of fuel decay products in general.

Elimination of such phenomena as bedding rings or coking of the combustion chamber and the ability to reduce the injection angle will increase lifespan.

Since the obtaining of hydrogen containing gases is possible using various types of liquid fuels, the proposed method ensures the use of a “multi-fuel” for engine operation.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method for improving performance and efficiency of diesel, gas-turbine, turbojet internal combustion engine, comprising:
decomposing a fuel into constituent parts;
obtaining hydrogen-containing gases from a portion of the split fuel;
injecting the previously split fuel into a combustion chamber;
igniting the hydrogen-containing gases at the time of injection of the fuel; and
igniting a remaining portion of the injected fuel.

2. The method of claim 1, wherein the fuel is decomposed by overheating.

3. The method of claim 2, wherein the overheating above the self-ignition temperature of the fuel.

4. The method of claim 1, wherein during the moment of the injection of the previously split fuel, water is supplied in parallel with the previously split fuel.

5. The method of claim 1, further comprising dissolving water in the fuel.

6. The method of claim 5, wherein the water is under the impact of extreme temperatures Tₑₓₜᵣ≧374° C. at a pressure of P≧218 atm.

7. The method of claim 1, wherein the step of igniting the hydrogen-containing gasses occurs via formation of a torch from the hydrogen-containing gases.

8. A method for improving performance and efficiency of diesel, gas-turbine, turbojet internal combustion engine, comprising:
decomposing a fuel into constituent parts;
obtaining hydrogen-containing gases from a portion of the split fuel;
injecting the previously split fuel into a combustion chamber;
injecting water in parallel with the previously split fuel into the combustion chamber;
igniting the hydrogen-containing gases at the time of injection of the fuel; and
igniting a remaining portion of the injected fuel.

9. The method of claim 8, wherein the fuel is decomposed by overheating.

10. The method of claim 9, wherein the overheating above the self-ignition temperature of the fuel.

11. The method of claim 8, further comprising dissolving water in the fuel.

12. The method of claim 11, wherein the water is under the impact of extreme temperatures Tₑₓₜᵣ≧374° C. at a pressure of P≧218 atm.

13. The method of claim 8, wherein the step of igniting the hydrogen-containing gasses occurs via formation of a torch from the hydrogen-containing gases.
